(19) United States
(12) Patent Application Publication
(10) Pub. No.: US 2026/0037105 A1
(43) Pub. Date: Feb. 5, 2026

(54) METHOD, COMPUTER PROGRAM, DEVICE AND USER INTERFACE FOR RESTORING AUTOMATICALLY RESET SETTINGS OF A MACHINE

(71) Applicant: Volkswagen Aktiengesellschaft, Wolfsburg (DE)

(72) Inventors: Johanna Sandbrink, Braunschweig (DE); Marie Puhle, Braunschweig (DE); Margret Siegmund, Gifhorn (DE); Markus Neumann, Vordorf (DE); Gordon Seitz, Ehra-Lessien (DE); Martin Hofmann, Lehre (DE)

(21) Appl. No.: 18/727,648

(22) PCT Filed: Oct. 19, 2022
(86) PCT No.: PCT/EP2022/079050

§ 371 Date: Jul. 9, 2024

(30) Foreign Application Priority Data
Jan. 12, 2022 (DE) 102022200235.0

(51) Int. Cl. G06F 3/0484; G06F 3/0482; G06F 3/0488

(52) U.S. Cl. CPC G06F 3/0484; G06F 3/0482; G06F 3/0488

(57) ABSTRACT

A method, computer program including instructions, device, and user interface for restoring automatically reset settings of a machine are disclosed. Additionally, a machine utilizing the method, device, or user interface is provided. The method includes displaying an indication of the presence of automatically reset settings. Upon detecting an actuation of an assigned operating element, a display of a list of the reset settings is generated on a display device, and at least one operating element for restoring at least one reset setting is provided. Thereafter, the actuation of at least one provided operating element is detected, and in response, the at least one reset setting is restored.

### RELATED APPLICATIONS

The present application claims priority to International Patent App. No. PCT/EP2022/079050 to Sandbrink, et al., titled “Method, Computer Program, Device And User Interface For Restoring Automatically Reset Settings Of A Machine”, filed Oct. 19, 2022, which claims priority to German Patent App. No. 10 2022 200 235.0, filed on Jan. 12, 2022, the contents of each being incorporated by reference in their entirety herein.

### TECHNICAL FIELD

The present disclosure relates to a method, to a computer program including instructions, to a device, and to a user interface for restoring automatically reset settings of a machine. The present disclosure furthermore relates to a machine in which corresponding methods, devices or user interfaces disclosed herein are used.

### BACKGROUND

Specific settings of a machine, for example of a means of transportation, are generally stored for the particular user within the scope of personalization by the machine being switched off and switched on again.

For example, DE 10 2015 007 741 A1 describes a method for operating a vehicle by providing multiple profiles, each of which contains user-specific settings data for the vehicle. An initial selection of one of the profiles is carried out by means of an instrument cluster of the vehicle. In contrast, changing or managing the respective selected profile is carried out with a main unit of the vehicle.

DE 100 12 756 B4 describes a method for storing and retrieving individual settings of operationally relevant electrically settable or adjustable elements in the motor vehicle. In the method, a user identification or user assignment is queried via a display during start-up of the vehicle. Memory keys or memory keypads are generated for this purpose on the display, the actuation of which retrieves a previously stored identifier. Additionally, a guest key is generated, the actuation of which results in a guest identifier. An actuation of the guest key prompts a request to set all settable elements, wherein the settings of the settable elements carried out after actuation of the guest key are not stored.

Due to approval regulations or statutory requirements, certain settings that the user carries out in a means of transportation cannot be permanently saved in means of transportation. These settings must automatically be reset to a defined standard value every time the means of transportation is started. In general, all functions that are automatically reset to a standard value must be individually adapted again to the desired settings by the user in various menus for vehicle settings of an infotainment system.

### SUMMARY

Aspects of the present disclosure are directed to improving configurations for restoring automatically reset settings of a machine.

Aspects of the present disclosure are described in the features recited in the independent claims, found below. Further aspects are described in the features recited in the dependent claims.

In some examples, a method is disclosed for restoring automatically reset settings of a machine comprising: generating a display of a list of the reset settings on a display device; detecting an actuation of at least one operating element for restoring at least one reset setting; and in response to the actuation of the at least one operating element, restoring the at least one reset setting.

In some examples, a computer program is disclosed, including instructions which, during execution by a computer, prompt the computer to carry out the following steps for restoring automatically reset settings of a machine: generating a display of a list of the reset settings on a display device; detecting an actuation of at least one operating element for restoring at least one reset setting; and in response to the actuation of the at least one operating element, restoring the at least one reset setting.

The term ‘computer’ as used herein shall be understood broadly. In particular, the term also encompasses control units, embedded systems, and other processor-based data processing devices.

The computer program can, for example, be provided for electronic retrieval or be stored on a computer-readable memory medium.

In some examples, a device is disclosed for restoring automatically reset settings of a machine, the device comprising: a graphics module for generating a display of a list of the reset settings on a display device; an evaluation module for detecting an actuation of at least one operating element for restoring at least one reset setting; and a control module for restoring the at least one reset setting in response to the actuation of the at least one operating element.

In some examples, a user interface is disclosed for a user of a machine comprises at least one operating element for restoring at least one reset setting of the machine.

In some examples, a combination of functions, or at least all of the functions of a defined portfolio of functions, may be configured to automatically reset in one menu. In this way, the user is offered a simple and efficient option for setting the functions in question back to the desired values or to restore the previous settings.

The methods and/or devices disclosed herein may be advantageously used in a machine, in particular in a means of transportation. The means of transportation may, for example, be a motor vehicle, for example a passenger car or a commercial vehicle. The use of the examples and embodiments disclosed herein may provide a user a simple and efficient option for setting automatically reset settings back to the desired values. It should be understood by those skilled in the art that the examples and embodiments provided herein are not limited to means of transportation. A use is also possible in other types of machines, for example in washing machines, televisions, charging stations, and the like.

### BRIEF DESCRIPTION OF THE DRAWINGS

Further features of the present disclosure may be derived from the following description and the accompanying claims, in conjunction with the figures.

FIG. 1 schematically shows a method for restoring automatically reset settings of a machine, according to come aspects of the present disclosure;

FIG. 2 shows an example of a device for restoring automatically reset settings of a machine, according to come aspects of the present disclosure;

FIG. 3 shows another example of a device for restoring automatically reset settings of a machine, according to come aspects of the present disclosure;

FIG. 4 schematically shows a means of transportation utilized as an exemplary machine, according to come aspects of the present disclosure,

FIG. 5 schematically shows an example of a user interface with an indication of the presence of automatically reset settings, according to come aspects of the present disclosure;

FIG. 6 schematically shows another example of a user interface with an indication of the presence of automatically reset settings, according to come aspects of the present disclosure;

FIG. 7 schematically shows a further example of a user interface with an indication of the presence of automatically reset settings, according to come aspects of the present disclosure;

FIG. 8 schematically shows yet another example of a user interface with an indication of the presence of automatically reset settings, according to come aspects of the present disclosure;

FIG. 9 schematically shows an option for accessing a list of automatically reset listings in a control center, according to come aspects of the present disclosure;

FIG. 10 schematically shows a list of the reset settings with a single entry, according to come aspects of the present disclosure;

FIG. 11 schematically shows a list of the reset settings with multiple entries, according to come aspects of the present disclosure;

FIG. 12 schematically shows a list of the reset settings with multiple entries, according to come aspects of the present disclosure; and

FIG. 13 schematically shows a list of the reset settings with a global switch, according to come aspects of the present disclosure.

### DETAILED DESCRIPTION

To provide a better understanding of the principles of the present disclosure, embodiments will be described hereafter in greater detail based on the figures. It shall be understood that the present disclosure is not limited to these embodiments, and that the described features can also be combined or modified, without departing from the scope of protection defined in the accompanying claims.

In some examples, an indication of the presence of automatically reset settings is displayed, and the list of the reset settings is displayed in response to an actuation of an operating element. The indication can be displayed, for example, in the form of a graphical pop-up containing indication text, in the form of indication text, or in the form of a symbol in a welcome display, or in the form of indication text or a symbol in an operating or information menu. The indication illustrates the resetting of settings to the user so that the user can decide whether to restore settings. Preferably, a time period is provided, the elapse of which causes the indication to be turned off. In this case, the list of reset settings can be opened via a separate menu entry.

In some examples, the indication is configured as an operating element. In this case, the user can access the list of reset settings by merely tapping the indication. This enables very intuitive operation.

In some examples, the indication or the list of the reset settings is automatically displayed after the machine has been started or a user of the machine has logged in. The display of the indication or of the list, for example, during the start of a means of transportation, such as when a start button is actuated, has the advantage that the operator can restore the desired settings even before starting to drive. Additionally, the operator is proactively informed that settings were automatically reset, and a list of the most relevant changes is displayed. If the operator logs in, the settings can be restored in a personalized manner so that different settings are possible depending on the operator.

In some examples, the automatic displaying of the indication or the list of reset settings can be turned off. This allows the user of the machine to utilize or deactivate the offered functionality as desired. The functionality can be turned off or activated, for example, by means of corresponding control elements, such as checkboxes. These may be an integral part of the initial indication or the list of reset settings. Alternatively, these may also be provided in an operating or information menu. When turning off the functionality, the user preferably receives an indication as to how and/or where it can be reactivated later.

In some examples, the display device is configured to be touch-sensitive. This allows the operation to be carried out directly in the image content displayed by the display device, enabling particularly intuitive operation.

In some examples, the operating elements are configured as buttons or slider controls on the display device. The use of simple buttons has the advantage that mere tapping of the button suffices to change the associated setting. Slider controls, in contrast, allow more complex interactions. For example, a swipe gesture may be required for deactivating a function, particularly a safety-relevant function, to preclude inadvertent deactivation. Due to the interaction method-pressing/touching combined with pulling—this becomes a complex interaction regarded as two operating steps. This can increase the safety requirement for operation and satisfy statutory requirements for a minimum number of operating steps.

In some examples, exactly one reset setting, a selection of reset settings, or all reset settings are restored by the actuation of the at least one operating element. This allows for influencing the number of operating elements that have to be provided and how the settings can be individually restored. The restoration of all reset settings by a single operating action is especially convenient for the user. The user can preferably configure the approach for the restoration.

In some examples, information about the reset settings can be accessed via an operating element. This allows conveying to the user why settings were reset, thereby avoiding the impression that a malfunction may be present.

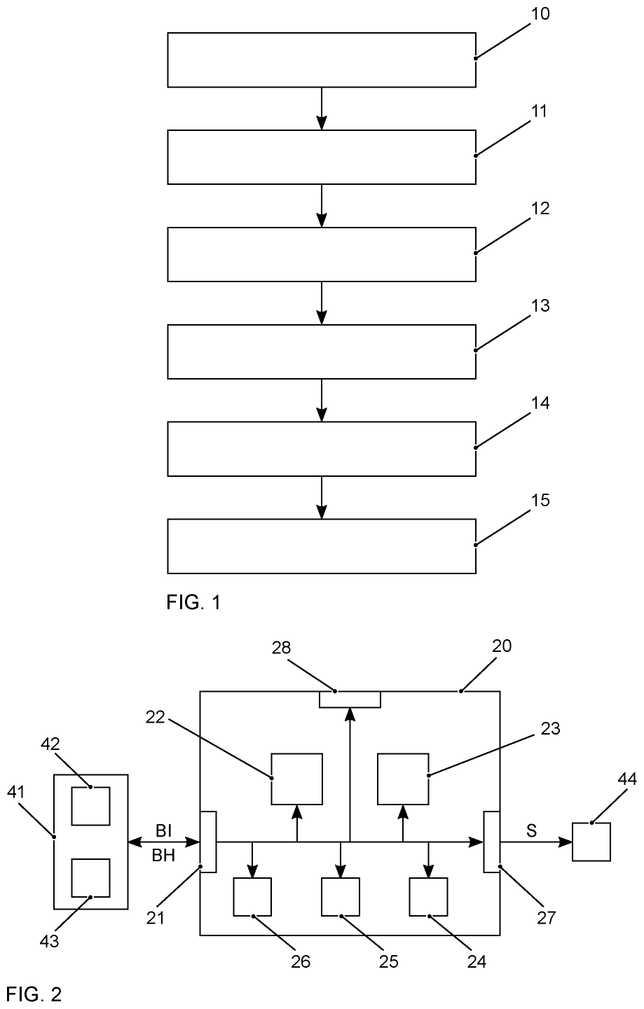

FIG. 1 schematically shows a method for automatically restoring reset settings of a machine. In the first step, an indication of the presence of automatically reset settings can be displayed (10) on a display device. If an assigned operating element is then activated (11), a list of the reset settings is generated (12) and displayed on the device. At least one operating element is provided (13) for restoring the reset settings. The indication of the presence of automatically reset settings is preferably configured as an operating element. The display device can be touch-sensitive to facilitate this. Then, the activation of at least one provided operating element is detected (14). The operating elements can be buttons or slider controls, for example, on the display device. In response to the activation of the operating element(s), the reset setting(s) is restored (15). One, a selection, or all of the reset settings can be restored by activating the operating element(s). Additionally, there may be a further operating element that provides information about the reset settings. Preferably, the indication or the list of the reset settings is automatically displayed (10, 12) after the machine is started or when a user logs in. The automatic displaying 10, 12 of the indication or list of reset settings can be deactivated if desired.

FIG. 2 shows a simplified schematic representation of a first embodiment of a device 20 for automatically restoring reset settings of a machine. The device 20 includes an interface 21 for exchanging information with an infotainment system 41, such as image content BI and information about operating actions BH. The infotainment system 41 comprises a touch-sensitive display device 42 and an input device 43. A graphics module 22 is capable of generating an indication of the presence of reset settings, which can be displayed on the display device 42. When an assigned operating element on the input device 43 is activated, the graphics module 22 generates a list of the reset settings for display on the display device 42. The indication of reset settings is preferably configured as an operating element. An evaluation module 23 can detect the activation of at least one operating element on the input device 43 in order to restore at least one reset setting. The operating elements may be buttons or slider controls on the display device. A control module 24 is responsible for restoring the reset settings in response to the activation of the operating element(s). It can output control commands S via an output 27 of the device 20 to an assistance system 44 affected by the setting. The control module 24 can restore exactly one, a selection, or all of the reset settings, depending on the activation of the operating element(s). Additionally, information about the reset settings can be accessed through another operating element. The indication or the list of reset settings is automatically displayed after the machine is started or when a user logs in. The automatic display of the indication or the list of reset settings can be deactivated.

The graphics module 22, the evaluation module 23, and the control module 24 can be controlled by the check module 25. Settings of the graphics module 22, the evaluation module 23, the control module 24, or the check module 25 can be changed, if necessary, via a user interface 28. The data generated by the device 20 can be saved, if needed, to a memory 26, for example, for later evaluation or for use by the components of the device 20. The graphics module 22, the evaluation module 23, the control module 24, and the check module 25 can be implemented as dedicated hardware, such as integrated circuits. However, they can also be partially or completely combined or implemented as software running on a suitable processor, such as a GPU or a CPU. The interface 21 and the output 27 can be implemented as separate interfaces or as one combined bidirectional interface.

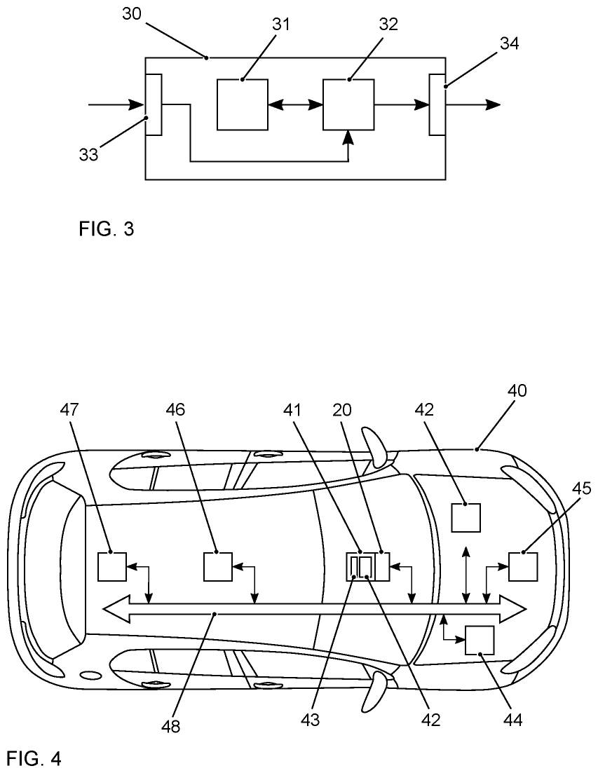

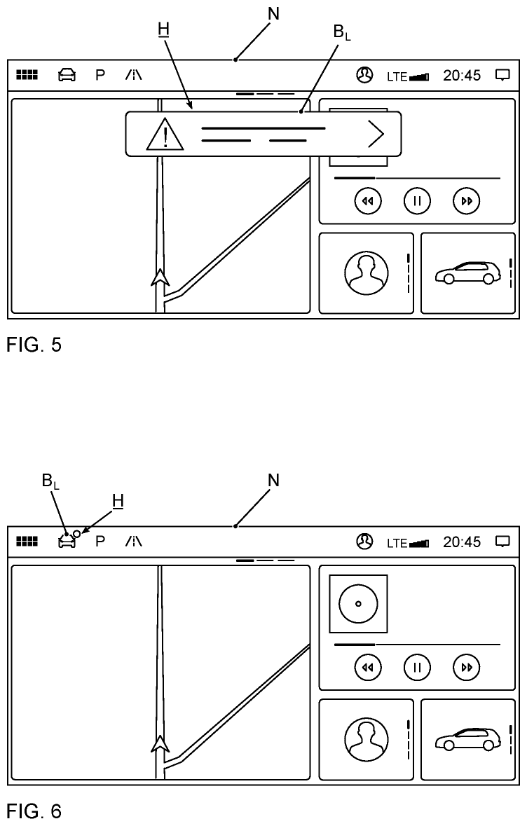

FIG. 3 shows a simplified schematic representation of a second embodiment of a device for automatically restoring reset settings of a machine. The device 30 comprises a processor 32 and a memory 31. For example, the device 30 can be a computer or a control unit. Instructions are stored in the memory 31, which prompt the device 30 to carry out the steps according to one of the described methods when executed by the processor 32. Thus, the instructions stored in the memory 31 embody a program that can be executed by the processor 32 and implements the method according to the present disclosure. The device 30 has an input 33 for receiving information, such as operating actions of a user of the machine. Data generated by the processor 32 is provided via an output 34. Additionally, the data can be stored in the memory 31. The input 33 and the output 34 can be combined to form a bidirectional interface. The processor 32 can include one or more processor units, such as microprocessors, digital signal processors, or combinations thereof. The memories 26, 31 of the described embodiments can include both volatile and non-volatile memory areas and encompass a wide variety of memory devices and media, such as hard disks, optical memory, or semiconductor memories.

FIG. 4 schematically shows a motor vehicle as an example of a machine 40 in which a solution according to the present disclosure is implemented. The motor vehicle includes an infotainment system 41 with a touch-sensitive display device 42 and an input device 43. An operator of the motor vehicle can change settings of the vehicle, such as activating, deactivating, or configuring assistance systems 44, using the infotainment system 41. With the help of a device 20 according to the present disclosure, it is possible to automatically restore reset settings after the motor vehicle has been started or the operator has logged in. Other components of the motor vehicle include a surroundings sensor system 45 for detecting surroundings information, such as cameras, radar sensors, LIDAR sensors, or ultrasonic sensors, as well as a data transmission unit 46. The data transmission unit 46 can be used, for example, to establish a link to a backend system for transmitting settings or running updated software for the motor vehicle components. A memory 47 is present for storing data. The exchange of data between the various components of the motor vehicle is done through a network 48.

In the following, several possible implementations of the solution according to the present disclosure will be demonstrated based on different configurations of user interfaces for a motor vehicle.

FIG. 6 shows a second embodiment of a user interface N with an indication H of the presence of automatically reset settings. In this embodiment, a marking appears on a symbol for a control center, serving as the indication H. The user must touch the symbol to access the list of reset settings, making the symbol an operating element BL. The marking on the symbol is less conspicuous than a pop-up but may be preferred for design reasons.

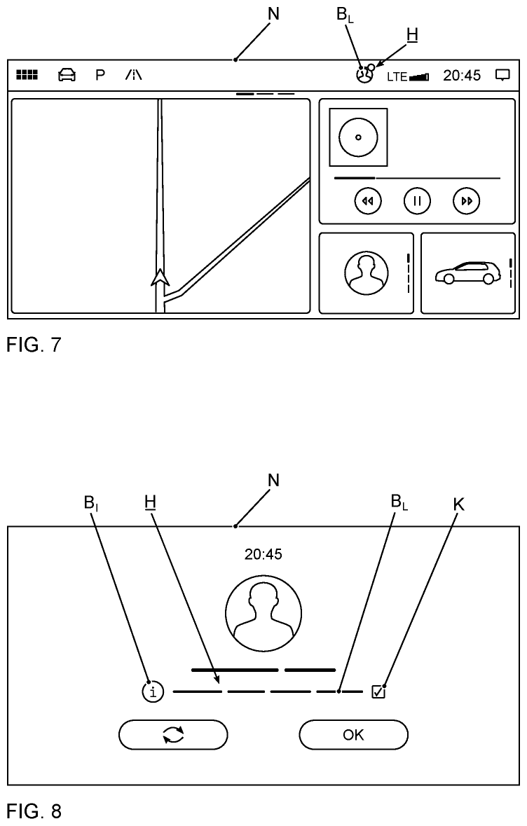

FIG. 7 schematically shows a third embodiment of a user interface N with an indication H of the presence of automatically reset settings. In this embodiment, a marking appears on a user symbol, serving as the indication H. The user must touch the user symbol to access the list of reset settings, making the user symbol an operating element BL. The marking on the user symbol is less conspicuous than a pop-up but very intuitive to understand since the user symbol is used to access user-based settings.

FIG. 8 schematically shows a fourth embodiment of a user interface N with an indication H of the presence of automatically reset settings. In this embodiment, a text indication appears in a welcome display message, serving as the indication H. The user must touch the text indication to access the list of reset settings, making the text indication an operating element BL. In this example, a check element K is provided next to the text indication, which is a checkbox that can be used to turn off the display of the indication H. Another operating element BI is displayed to the left of the text indication, providing access to information about the reset settings E. This allows the user to understand why the settings were reset through information text, for example.

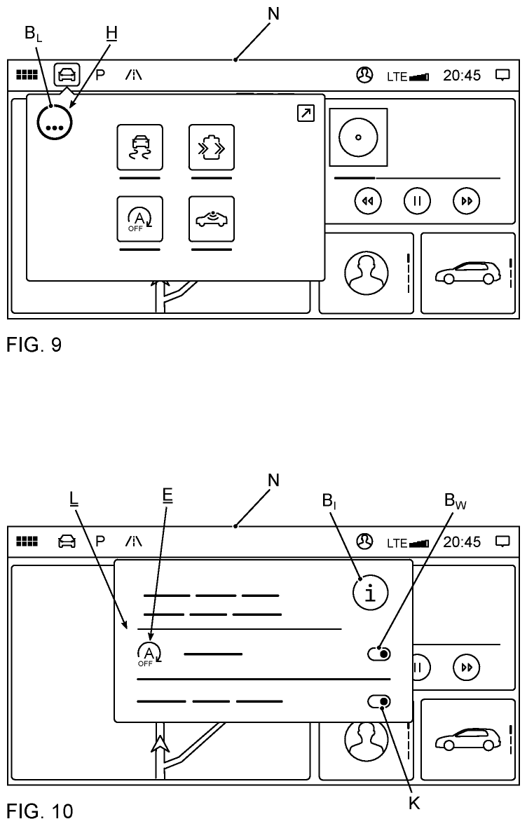

FIG. 9 schematically shows an option for accessing or re-accessing a list of automatically reset settings in a control center. In the control center, a highlighted button serves as the indication H of the presence of automatically reset settings. The user must touch the button to access the list of reset settings, making the button an operating element BL. If there are no automatically reset settings, the button is shown in a reduced design. When the button is pressed, an indication text may be displayed, such as “no automatically reset settings are present.” In addition to the indication text, a check element can be provided to allow the user to turn off the display of the indication in the future. Optionally, the list of reset settings can also be accessed through other means, such as an entry in an event display.

FIG. 10 schematically shows a list L of the reset settings E. In this example, the list L only contains a single reset setting E, here a start/stop function. An operating element Bw is displayed next to the reset setting E, which also illustrates the current setting. In the example shown, the start/stop function is activated. By pressing the operating element Bw, the user can restore the previous setting. In addition to the reset setting E, there is a check element K, which can be used to turn off the display of the indication in the future. The check element K also allows the display of the indication to be turned on again at a later time. Furthermore, there is another operating element BI, which provides access to information about the reset settings E. This allows the user to understand why the settings E were reset, for example, through information text.

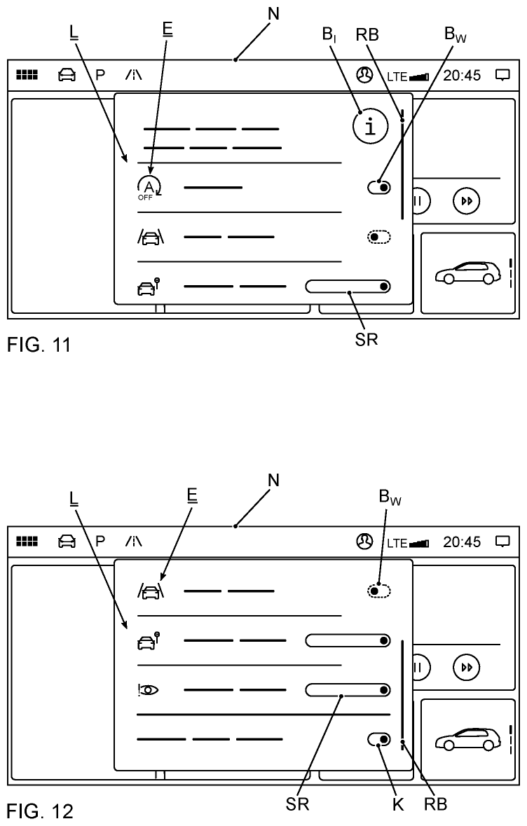

FIG. 11 schematically shows a list of reset settings E with multiple entries. Since the list L contains all of the most recently automatically reset settings E, the length of the list is dynamic. In this example, it is not possible to display all reset settings E simultaneously. Therefore, the list L has a scroll bar RB, which allows further entries to be accessed. This is shown in FIG. 12. A respective operating element Bw for restoring the respective reset setting E is displayed next to each reset setting E. The operating element Bw also illustrates the current setting. For more complex interactions, some of the operating elements Bw are implemented as elongated slider controls SR. When using these operating elements Bw, a swipe gesture is required to restore the previous setting in order to prevent accidental changes and to possibly comply with statutory requirements regarding the minimum number of operating steps. The slider control SR allows different behaviors to be implemented for activation and deactivation. For example, a swipe gesture consisting of pressing/touching and swiping can be used for deactivation, while a simple touch can be used for activation, if there is no requirement for a complex operating gesture or multiple operating steps. Alternatively, a two-step operation can be provided instead of the slider control SR as a complex operating element to meet the requirement for multiple operating steps. In addition to the reset settings E, there is a check element K, as also seen in FIG. 10, which can be used to turn off the display of the indication.

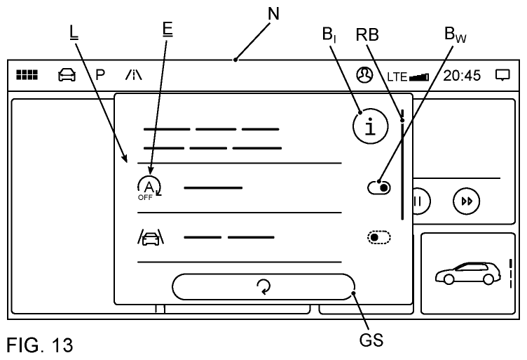

FIG. 13 schematically shows a list L of reset settings with a global switch GS. The representation of the list L is essentially the same as the representation shown in FIG. 11. However, in this case, below the list L, a global switch GS is displayed as the operating element Bw, which, when activated, allows all settings E to be restored with a single action. Manual operation of individual entries continues to be possible without restrictions.

The above-described operating elements Bw preferably work in both directions, so that it is possible not only to restore previous settings, but also to activate or deactivate the functions again later. For example, the lane-keeping assistance system can be automatically set to “active” when the vehicle is started. With the solution according to the present disclosure, the driver has the option to quickly and easily deactivate the function again. However, during the trip, the driver can also decide to reactivate the function and can reopen the list L, for example, via the control center. The function can then be reactivated through the list entry.

### LIST OF REFERENCE SIGNS

10 displaying an indication of reset settings
11 detecting an actuation of an operating element
12 generating a display of a list of reset settings
13 providing at least one operating element
14 detecting an actuation of an operating element
15 restoring at least one reset setting
20 device
21 interface
22 graphics module
23 evaluation module
24 control module
25 check module
26 memory
27 output
28 user interface
30 device
31 memory
32 processor
33 input
34 output
40 machine
41 infotainment system
42 display device
43 input device
44 assistance system
45 surroundings sensor system
46 data transmission unit
47 memory
48 network
BI operating element
BL operating element
Bw operating element
BH information regarding operating actions
BI image content to be displayed
E setting
GS global switch
H indication
K check element
L list
N user interface
RB scroll bar
S control command
SR slider control

1-15. (canceled)

16. A method for restoring automatically reset settings of a machine, comprising:
generating a display of a list of the reset settings on a display device;
detecting an actuation of at least one operating element for restoring at least one reset setting; and
restoring the at least one reset setting in response to the actuation of the at least one operating element.

17. The method of claim 16, further comprising displaying an indication of the presence of automatically reset settings, and displaying the list of the reset settings in response to an actuation of an operating element.

18. The method of claim 17, wherein the indication is configured as an operating element.

19. The method of claim 16, further comprising automatically displaying the indication or the list of the reset settings after the machine has been started or a user of the machine has logged in.

20. The method of claim 19, wherein the automatic displaying of the indication or the list of the reset settings can be turned off.

21. The method of claim 16, wherein the display device is configured to be touch-sensitive.

22. The method of claim 21, wherein the operating elements are configured as buttons or slider controls on the display device.

23. The method of claim 16, wherein exactly one reset setting, a selection of reset settings, or all of the reset settings are restored by the actuation of the at least one operating element.

24. The method of claim 16, wherein information about the reset settings can be accessed by way of an operating element.

25. A device for restoring automatically reset settings of a machine, comprising:
a graphics module for generating a display of a list of the reset settings on a display device;
an evaluation module for detecting an actuation of at least one operating element for restoring at least one reset setting; and
a control module for restoring the at least one reset setting in response to the actuation of the at least one operating element.

26. The device of claim 25, further comprising an indication module for displaying an indication of the presence of automatically reset settings, wherein the graphics module generates the list of the reset settings in response to an actuation of an operating element.

27. The device of claim 26, wherein the indication module is configured as an

28. The device of claim 25, wherein the indication module or the list of the reset settings is automatically displayed by the graphics module after the machine has been started or a user of the machine has logged in.

29. The device of claim 28, wherein the automatic displaying of the indication or the list of the reset settings can be turned off by a user.

30. The device of claim 25, wherein the display device is configured to be touch-sensitive.

31. The device of claim 30, wherein the operating elements are configured as buttons or slider controls on the display device.

32. The device of claim 25, wherein the control module is configured to restore exactly one reset setting, a selection of reset settings, or all of the reset settings in response to the actuation of the at least one operating element.

33. The device of claim 25, further comprising an information module for accessing information about the reset settings via an operating element.

34. A non-transitory computer-readable storage medium storing instructions that, when executed by a processor, cause the processor to:
generate a display of a list of the reset settings on a display device;
detect an actuation of at least one operating element for restoring at least one reset setting; and
restore the at least one reset setting in response to the actuation of the at least one

35. The non-transitory computer-readable storage medium of claim 34, further storing instructions that, when executed by the processor, cause the processor to:
display an indication of the presence of automatically reset settings; and
display the list of the reset settings in response to an actuation of an operating element.
